(19) United States
(12) Patent Application Publication
(10) Pub. No.: US 2008/0206520 A1
(43) Pub. Date: Aug. 28, 2008

(54) Surface-modified metal member and method of modifying metal surface

(75) Inventors: Shinichiro Il, Hadano-shi (JP); Tatsumi Onishi, Yokohama-shi (JP); Kenji Suzuki, Koshigaya-shi (JP); Tomio Matsuzaki, Hadano-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/068,342

(22) Filed: Feb. 5, 2008

(30) Foreign Application Priority Data
Feb. 7, 2007 (JP) 2007-027523

(51) Int. Cl. B32B 3/30; B32B 15/08; B32B 15/09; H05H 1/00; C09J 143/04; C09J 175/04; C09J 163/00; B32B 15/092; B32B 15/095

(52) U.S. Cl. 428/172; 428/463; 428/425.8; 428/418; 428/447; 428/336; 204/157.15; 204/164; 156/329; 156/330; 156/331.7

(57) ABSTRACT

A surface-modified member including a metal base, a surface modification layer formed on at least a part of a surface of the metal base, the surface modification layer containing a metal hydroxide, and at least one of a curable resin layer, an ink layer and a coating material layer which is provided on at least a portion of the surface modification layer. A method of modifying a surface of a metal member, including applying an energy to at least a part of the surface of the metal member to produce a metal hydroxide on the surface of the metal member.

### BACKGROUND OF THE INVENTION

The present invention relates to a surface modifying technology for metal, typically, aluminum alloy and magnesium alloy. Specifically, the present invention relates to a method of modifying a surface of a metal member which is capable of activating the metal surface and forming a modification layer having excellent bonding property and coating property on the metal surface, and relates to a metal member that is surface-modified by the method and can exhibit excellent bonding property and coating property.

In recent years, for the purpose of reducing a vehicle weight, light metal materials that contains aluminum or magnesium as a main component have been increasingly used as well as resin materials, for instance, polyethylene and polypropylene.

Conventionally, in various technical fields such as metal working, resin treatment, functional material production and machine assembly and working, there has been a demand for a technology of bonding different kinds of light metal materials to each other or bonding the light metal materials to a member made of other materials to thereby form an integral member. A great number of adhesives have been developed in order to satisfy the above demand, and some of these adhesives exhibit a very excellent bonding property. Such a progress of the bonding technology is supported by development of technology of surface modification for the light metal materials to be bonded as well as technology of the adhesives. The following methods of modifying a surface of the light metal materials to be bonded are generally known as surface pretreatment methods that are conducted before bonding.

In the case of aluminum alloy, in general, the surface of aluminum alloy is subjected to cleaning to remove soils and oils from the alloy surface, and then to chromic acid treatment. With the chromic acid treatment, a rigid metal oxide film is generated on the surface of aluminum alloy to thereby stabilize the surface of aluminum alloy, and the surface of aluminum alloy thus stabilized by the rigid metal oxide film generated on the surface is rendered coarse by etching. In the case of magnesium alloy, the surface of magnesium alloy is completely degreased with sodium phosphate or sodium silicate, and then subjected to zinc phosphate treatment to form a zinc phosphate film thereon which has a highly irregular surface.

As described above, formation of the rigid metal oxide film or formation of the zinc phosphate film having the highly irregular surface is generally known as the surface modifying method for light metal materials as an adherend, i.e., the surface treatment before bonding. The surface of aluminum alloy or the surface of magnesium alloy can be suitably prepared for bonding or coating by these pretreatment methods.

However, metal materials useable in the zinc phosphate pretreatment are limited in view of corrosion resistance after the surface pretreatment. Further, since sludge is produced as a by-product of the reaction in the zinc phosphate pretreatment, heavy burden imposes on environment. Further, the zinc phosphate pretreatment needs high cost. In addition, the chromic acid treatment using a treatment liquid containing poisonous hexavalent chromium should be avoided in view of environmental regulations in these days.

Under the circumstances, there have been proposed pretreatments using a treatment liquid that is free from such a poisonous component. For instance, Japanese Patent Application First Publication No. 2000-204485 describes a chromium-free coating agent for a metal surface which contains a nitrogen-containing compound having lone electron pairs, both the nitrogen-containing compound and a zirconium-containing compound. Further, Japanese Patent Application First Publication No. 5-195244, corresponding to U.S. Pat. No. 5,342,456 and U.S. Pat. No. 5,449,414, describes a surface treatment using a chromium-free acid composition in which, for instance, a stabilized film is formed on a metal surface by baking and drying without washing after treatment using an aqueous solution of a component that is capable of forming an excellent anti-corrosion film.

### SUMMARY OF THE INVENTION

However, the chromium-free coating agent capable of forming a surface treatment film without the harmful hexavalent chromium as described in Japanese Patent Application First Publication No. 2000-204485 is useable only for aluminum alloy, and the surface treatment film is formed by the surface treatment and drying. Therefore, it is difficult to uniformly treat a complicated structure such as vehicle parts. The surface treatment described in Japanese Patent Application First Publication No. 5-195244 is applicable to various kinds of metal materials including magnesium alloy and aluminum alloy because the film can be generated without chemical reactions. However, similar to the chromium-free coating agent as described above, the film is formed by surface treatment and drying, whereby the complicated structure such as vehicle parts could not be uniformly treated.

On the other hand, a method of physically treating a metal surface, for instance, shot blasting using shots made of alumina, stainless or the like, and polishing using sand paper, a wire brush or a grinder, is generally adopted as a pretreatment before bonding. However, if a metal member to be subjected to the physical surface treatment is formed by extrusion or casting, the metal member cannot be uniformly treated by the physical surface treatment due to an uneven thickness of an oxide film or a mold releasing agent which remains on a surface of the metal member. As a result, there occurs fluctuation in bonding property and adhesion property of the film to a surface of the metal member owing to the remaining oxide film and mold releasing agent. Further, fine particles of the metal member which are generated during the physical treatment are attached to the surface. Therefore, it is necessary to subject the surface of the metal member to cleaning and degreasing.

The present invention has been made in view of the above-described problems encountered in the conventional surface treatment and surface modifying technologies. An object of the present invention is to provide a surface-modified member that is produced by the surface modifying method and has an excellent bonding or coating property, and provide a surface modifying method for metal materials including aluminum alloy and magnesium alloy which is capable of activating a surface of the metal materials to thereby form a surface modification layer having an excellent bonding or coating property.

As a result of extensive and intensive studies, the inventors have found that the above object can be achieved by applying an energy to the metal surface, for instance, by laser treatment, plasma treatment, ultraviolet (UV) irradiation treatment, corona treatment and flame treatment.

In one aspect of the present invention, there is provided a surface-modified member comprising:

a metal base;

a surface modification layer formed on at least a part of a surface of the metal base, the surface modification layer containing a metal hydroxide; and

at least one of a curable resin layer, an ink layer and a coating material layer which is provided on at least a portion of the surface modification layer.

In a further aspect of the present invention, there is provided a method of modifying a surface of a metal member, the method comprising:

applying an energy to at least a part of the surface of the metal member to produce a metal hydroxide on the surface of the metal member.

In a still further aspect of the present invention, there is provided a joined article comprising the surface-modified member as described above, and a counterpart member that is joined to the surface-modified member through the curable resin layer provided on the at least a portion of the surface modification layer.

In a still further aspect of the present invention, there is provided a method of producing the joined article using the surface-modified member as described above, the method comprising:

joining the surface-modified member to a counterpart member through the curable resin layer provided on the at least a portion of the surface modification layer.

The surface-modified member of the present invention can exhibit an excellent bonding and coating property, and therefore, the joined article that is formed by joining the surface-modified member and a counterpart member through a curable resin can exhibit an excellent bonding and coating durability. Further, the surface modification method of the present invention can activate a surface of a metal material to thereby enhance a bonding property and a coating property of the modified surface of the metal material treated by the surface modification method.

### BRIEF DESCRIPTION OF THE DRAWINGS

FIG. 1 is a schematic explanatory diagram that shows a dimension and a shape of a test piece used in Examples of a surface modifying treatment according to the present invention.

FIG. 2 is a schematic diagram that shows procedure for preparing a test specimen used in a bonding test in which the two test pieces for the surface modifying treatment are bonded to each other.

FIG. 3 is a graph that shows an example of an X-ray photoelectron spectroscopic analysis chart used for investigation of a surface condition of the test pieces used in Example 2, Example 3 and Comparative Example 1.

FIG. 4 is a graph that shows an example of an X-ray photoelectron spectroscopic analysis chart used for investigation of a surface condition of the test pieces used in Example 6, Example 7 and Comparative Example 5.

FIG. 5 is a SEM observation image of a surface configuration of a surface modification layer of the test piece used in Example 2.

FIG. 6 is a SEM observation image of a surface configuration of a surface modification layer of the test piece used in Example 3.

FIG. 7 is a SEM observation image of a surface configuration of a surface modification layer of the test piece used in Example 6.

FIG. 8 is a SEM observation image of a surface configuration of a surface modification layer of the test piece used in Example 7.

FIG. 9 is a SEM observation image of a surface configuration of a surface of the test piece used in Comparative Example 1.

FIG. 10 is a SEM observation image of a surface configuration of a surface of the test piece used in Comparative Example 6.

FIG. 11 is a SEM observation image of a surface configuration of a surface of the test piece used in Comparative Example 7.

### DETAILED DESCRIPTION OF THE INVENTION

In the following description, the surface-modified member and the surface modifying method according to the present invention will be described in details. Unless otherwise specified, the term “%” used in the following description means mass percentage.

The surface-modified member of the present invention includes a metal base; a surface modification layer formed on at least a part of a surface of the metal base and containing a hydroxide of the metal that forms the metal surface; and at least one of a curable resin layer, an ink layer and a coating material layer which is provided on at least a portion of a surface of the surface modification layer. The surface-modified member can be produced by the surface modifying method of the present invention in which an energy is applied to at least a part of a surface of a metal member to thereby produce a metal hydroxide on the surface of the metal member.

In the surface modifying method of the present invention, various kinds of metals or metal compounds which are previously present on the surface of the metal member are chemically changed to a metal hydroxide by the energy applied to the metal surface. As a result, it is possible to obtain an effect of surface modification on the basis of generation of the metal hydroxide. Therefore, the surface modification method of the present invention can be performed with high efficiency and high reliability without causing deterioration of the surface modification layer or reduction in strength of a base material of the metal member to be treated.

Specifically, by applying the energy to the metal surface, the metal hydroxide is produced on the metal surface to thereby form a modified surface. Consequently, when an adhesive or a coating is applied to the modified surface, a chemical bond, such as a covalent bond or a hydrogen bond, between a hydroxyl group of the metal hydroxide present on the modified surface and a functional group such as an acrylic or epoxy radical, an isocyanate radical and a hydroxyl radical which is contained in a resin as a component of the adhesive or the coating is formed on the modified surface. As a result, the modified surface can exhibit an extremely excellent bonding property or coating property, i.e., high adhesion of a coating material to the modified surface.

Further, as the method of confirming whether or not the metal hydroxide is produced on the metal surface by the surface modifying method of the present invention, for instance, an X-ray photoelectron spectroscopic analysis (XPS) may be used. The formation of the metal hydroxide can be easily recognized by calculating a binding energy between the metal atom and the oxygen atom in the hydroxide and contents (atomic %) of the metal atom and the oxygen atom on the basis of the XPS.

Metals that constitute the metal member to be treated by the surface modifying method of the present invention are not particularly limited, and any suitable metals and alloys as conventionally known may be used. Specific examples of the metals and alloys include metals and alloys which contain, as a main component, iron (Fe), nickel (Ni), copper (Cu), zinc (Zn), magnesium (Mg), aluminum (Al), silver (Ag), platinum (Pt), gold (Au), lead (Pb), tin (Sn), titanium (Ti), cobalt (Co), manganese (Mn), chromium (Cr), molybdenum (Mo), cadmium (Cd), tungsten (W) and iridium (Ir), and an alloy that contains any two or more kinds of these metals.

Among these metals and alloys as described above, aluminum, aluminum alloy and magnesium alloy are preferably treated by the surface modifying method of the present invention, because aluminum, aluminum alloy and magnesium alloy might form a hard oxide film on the surface which generally causes deterioration in bonding property or coating property of the metal surface. Further, since aluminum, aluminum alloy and magnesium alloy have a small specific gravity as compared to steel materials and steel plates as conventionally used, it is preferred that these metal and alloys are treated by the surface modifying method of the present invention in view of weight reduction of the metal member.

The aluminum alloy used is not particularly limited, and various kinds of aluminum alloys may be used. Examples of the aluminum alloys include aluminum alloy castings such as AC1A, AC1B, AC2A, AC2B, AC3A, AC4A, AAC4B, AC4C, AC4CH, AC4D, AC5A, AC7A, AC8A, AC8B, AC8C, AC9A and AC9B as prescribed in Japanese Industrial Standard (JIS) H 5202; aluminum alloy die castings such as ADC1, ADC3, ADC5, ADC6, ADC10, ADC10Z, ADC12, ADC12Z and ADC14 as prescribed in JIS H 5302; and aluminum alloy sheets and plates such as Alloy Nos. 2017, 2219, 3003, 3104, 4032, 5005, 5154, 6101, 6061, 7075 and 8021 as prescribed in JIS H 4000. Among these aluminum alloys, AC4C, ADC12, 5005, 5154, 6106, 6061 and 7075 are typical.

Further, the magnesium alloy is not particularly limited, and various kinds of magnesium alloys may be used. Examples of the magnesium alloys include AZ31, AZ31B, AZ61, AZ91, AZ91D, AM50, AM60 and AM60B as prescribed in Society of Automotive Engineers (SAE) J465. Here, the codes “AZ” and “AM” represent metal elements added to the magnesium alloy, in which the metal elements “A”, “M” and “Z” denote aluminum, manganese and zinc, respectively. The numerals following the codes indicate percentages of the metal elements added. For instance, AZ91 indicates that aluminum of 9% and zinc of 1% are contained in the magnesium alloy. Among these magnesium alloys, AZ31, AZ61, AZ91, AM60 and AM60B are typical.

A form of the metal member to be treated by the surface modifying method of the present invention is not particularly limited. The metal member formed by various molding methods that include casting with a metal mold or a sand mold, extruding, forging and pressing, may be used. Further, the surface of the metal member which is to be treated by the surface modifying treatment of the present invention is not limited to an entire area of the surface and may be only a local area of the surface which is to be subjected to bonding or coating.

A device or a method for applying an energy to the metal surface is not particularly limited, and various kinds of devices or methods as conventionally known may be used as long as the device or the method is capable of directly or indirectly applying the energy to the metal surface.

Examples of the devices include a laser treatment device (LASER: Light Amplification by Stimulated Emission of Radiation) which can irradiate the subject with various lights ranging from ultraviolet ray to infrared ray which have different wavelengths and can be used in marking, surface microscopic treatment and metal welding, a plasma treatment device that can generate plasma by glow discharge under reduced pressure and be used mainly for plasma polymerization to form a thin film, an ultraviolet irradiation device that can directly irradiate a substrate surface with ultraviolet rays using a low pressure mercury lamp or a high pressure mercury lamp as a light source, a corona treatment device that can perform corona discharge near a substrate surface and be used for enhancing wettability of a surface of a resin film or sheet, a flame treatment device that can be used for activating a surface of olefin resins such as polyethylene resin and polypropylene resin by using combustion of a mixed gas of propane gas and air, an electron beam irradiation device that can irradiate a substrate surface with a high energy electron beam accelerated by accelerating voltage, an ozone treatment device that can generate ozone by using a low pressure mercury lamp or an eximer lamp as a light source, an ion implantation device (ion beam irradiation device) that can irradiate a substrate surface with an optional ion beam accelerated in an electric field, and an infrared ray irradiation device that can directly irradiate a substrate surface with infrared rays by using an infrared lamp. Examples of the methods useable for applying energy to the metal surface include a method of heating a substrate surface using a heating device such as a heater, and a method of generating frictional heat on a substrate surface by a direct polishing method such as blasting and filing.

The method of directly applying energy to a metal surface by using the above-described devices includes, for example, a method of directly applying the energy emitted from the above-described devices to the metal surface in atmospheric air or in vacuum. The method of indirectly applying energy to a metal surface by using the above-described devices includes, for example, a method of applying the energy to the metal surface previously coated with an optional material in atmospheric air or in vacuum, and a method of applying the energy to the metal surface immersed in an oil or a chemical solution via a film of the oil or the chemical solution.

In the present invention, the laser treatment, the plasma treatment, the ultraviolet (UV) irradiation treatment, the corona treatment and the flame treatment as described above may be used alone or in combination of any two or more thereof. By using these treatments, an energy sufficient to modify the metal surface to be treated can be applied to the metal surface to thereby uniformly form a surface modification layer made of the metal hydroxide on the metal surface. The surface modifying treatment of the present invention can be performed with high efficiency and high reliability without causing deterioration of the surface modification layer or reduction in strength of a base material of the metal member to be subjected to the surface modifying treatment.

Particularly, it is preferred that the metal surface to be treated by the laser treatment is irradiated with laser light having wavelength of 500-1,100 nm at irradiation intensity of 100 to 90,000 W/mm².

By adopting such an irradiation condition, the metal and various kinds of the metal compounds previously present on the surface can be changed to the metal hydroxide to form a uniform surface modification layer containing the metal hydroxide on the surface without need of excessively melting the material to be treated. The surface modifying treatment of the present invention can be performed with high efficiency and high reliability without causing deterioration of the surface modification layer or reduction in strength of a base material of the metal member to be subjected to the surface modifying treatment.

Specifically, if the wavelength of the laser light irradiated is less than 500 nm, the metal and the metal compounds present on the metal surface to be treated cannot be changed to the metal hydroxide. On the other hand, if the wavelength of the laser light is more than 1100 nm, the material to be treated might be excessively molten by the thermal energy generated on the surface so that a uniform and adequate irregular shape, i.e., microscopic recesses and projections, cannot be formed on the surface modification layer containing the metal hydroxide. Further, if the irradiation intensity of the laser light is less than 100 W/mm², when the metal having an extremely low light absorption is treated, a uniform surface modification layer cannot be formed on the metal surface even by using the laser light having the wavelength ranging from 500 to 1100 nm as described above. If the irradiation intensity of the laser light is more than 90,000 W/mm², when the metal having an extremely high light absorption is treated, the metal surface might be excessively molten to thereby disturb uniform formation of the surface modification layer. Further, it is preferred that the irradiation intensity of the laser light is in a range of 200 to 30,000 W/mm². When the irradiation intensity of the laser light lies within the above-specified range, the effect of surface modification can be sufficiently obtained and the costs of equipment and maintenance can be reduced.

The laser used in the present invention is not particularly limited. Examples of the lasers include a YAG laser (yttrium aluminum garnet), a YVO₄ laser (yttrium vanadate), a semiconductor laser and a CO₂ laser. Among these lasers, the YAG laser and the YVO₄ laser are preferred. Also, lasers used in marking and microscopic machining can be applied to the surface modifying method. Accordingly, the costs of equipment can be reduced.

In the surface modifying method of the present invention, the metal hydroxides to be formed on the metal surface may be a compound containing at least one hydroxyl group. Examples of the metal hydroxides include magnesium hydroxide [Mg(OH)₂], aluminum hydroxide [Al(OH)₃, AlOOH], lead hydroxide [Pb(OH)₂], tin hydroxide [Sn(OH)₂, Sn(OH)₄], titanium hydroxide [Ti(OH)₃, Ti(OH)₄], chromium hydroxide [Cr(OH)₃], manganese hydroxide [Mn(OH)₂, Mn(OH)₃] and iron hydroxide [Fe(OH)₃, FeOOH].

In the surface-modified member of the present invention, the surface modification layer containing the metal hydroxide preferably has a thickness of 5 μm or less. In the surface-modified member having such a surface modification layer, a formation condition of the metal hydroxide in the surface modification layer and an irregular surface shape of the surface modification layer are suitably controlled. Therefore, when subjected to bonding, coating or printing using adhesive, paint or ink, the metal base having the surface modification layer can be reduced in fluctuation in bonding property or adhesion property of the adhesive, the paint or the ink to the surface modification layer and can exhibit excellent durability in bonding property and adhesion property.

Specifically, when the thickness of the surface modification layer is 5 μm or less, it is possible to provide a desired surface modification layer on which microscopic recesses and projections are evenly and suitably formed. Owing to the formation of the surface modification layer, upon subjecting the surface-modified member to bonding, coating or printing, the effect of surface modification can be sufficiently attained without occurrence of fracture in the surface-modified member due to deterioration in strength of the base material.

Further, it is preferred that the surface-modified member satisfies the relation represented by the following expressions (1) and (2):

1≦Ra/Rao≦20 (1)

Sm/Smo≦8 (2)

In the expression (1), Ra represents arithmetical mean roughness of the modified surface of the metal member after treated by the surface modifying treatment, and Rao represents arithmetical mean roughness of the surface of the metal member before treated by the surface modifying treatment. If the ratio Ra/Rao is 1 or more, the good irregularity having sufficient depth and height can be provided on the modified surface of the metal member. With the provision of the good irregularity, an anchoring effect can be attained upon subjecting the surface-modified metal member to bonding, coating or printing. As a result, sufficient bonding and adhesion durability of the surface-modified metal member can be obtained. Further, if the ratio Ra/Rao is 20 or less, the effect of surface modification can be more stably obtained without causing deterioration in strength of the base material even though the surface-modified metal member has a reduced thickness at the microscopic recesses.

In the expression (2), Sm represents an average distance between adjacent microscopic recesses or projections on the modified surface of the metal member after treated by the surface modifying treatment, and Smo represents an average distance between adjacent microscopic recesses or projections on the surface of the metal member before treated by the surface modifying treatment. If the ratio of Sm/Smo is 8 or less, the sufficient number of the microscopic recesses or projections per unit area can be formed on the modified surface of the metal member. This results in producing an anchoring effect upon subjecting the surface-modified metal member to bonding, coating or printing, so that sufficient bonding and adhesion durability of the surface-modified metal member can be ensured.

The term “arithmetical mean roughness” means the following value. A flat plate-shaped specimen having a size of 25 mm×125 mm×2 mm is cut out from a modified surface of the member subjected to the surface modifying treatment. A roughness curve is measured from an optional measuring point on a surface of the specimen by using a laser non-contact surface roughness meter or a tracer contact surface roughness meter. A reference length is sampled from the roughness curve along a direction of a mean line. An absolute value of deviation of the roughness curve of the reference length from the mean line is measured at optional five measuring points. The arithmetical mean roughness means an average value of the absolute values measured at the optional five measuring points.

The term “average distance between valleys and peaks” means the following value. A roughness curve of a flat plate-shaped specimen having the same size as described above is measured in the same manner as described above, and a reference length is sampled from the roughness curve along a direction of a mean line. A length of the mean line that corresponds to a distance between one valley and one peak adjacent to the valley in the reference length is measured at optional five measuring points on the roughness curve. The average distance between valleys and peaks means an average value of the lengths of the mean line as measured at the optional five measuring points.

Further, the surface-modified member may be joined to other member through a curable resin layer that is formed on the modified surface of the surface-modified member to thereby form a joined article.

The other member serving as a counterpart member is not particularly limited and may be a member or an article which is made from various kinds of materials. The surface-modified member of the present invention may also be used as the counterpart member. Examples of the counterpart member include a resin molded article made from a resin material such as polyolefine resin including polyethylene (PE) resin and polypropylene (PP) resin, polystyrene (PS) resin, polyvinyl chloride (PVC) resin, polyester resin, polyamide (PA) resin, polyamidimide (PAI) resin, acrylonitrile-butadiene-styrene (ABS) resin, polycarbonate (PC) resin, polyacetal (POM) resin, acrylic resin, urea resin, melamine resin, epoxy resin, phenol (PF) resin and polyphenylene sulfide (PPS) resin; a metal molded article made from a metal material such as a steel material, an aluminum alloy, a magnesium alloy, a copper alloy and a titanium alloy; a fabric made from a fiber material such as a carbon fiber, an aramid fiber, a glass fiber and a natural fiber; a rubber molded article made from a rubber material such as natural rubber, styrene-butadiene rubber (SBR), acrylonitrile-butadiene rubber (NBR) and ethylene propylene rubber (EPDM); a glass and a ceramic. Among these counterpart members, the resin molded article and the metal molded article are preferred.

A curable resin that forms the above-described curable resin layer is not particularly limited. Various kinds of curable resins may be used for forming the above-described curable resin layer as long as the curable resin applied to at least a portion of the modified surface of the surface-modified member, typically to a whole of the modified surface can be cured after joining the surface-modified member to the counterpart member made from an optional material through the curable resin. Examples of the curable resins include the following.

(1) hot melt resins such as polyolefine-based resins (e.g., polyethylene (PE)-based resin and ethylene-vinyl acetate (EVA)-based resin), synthetic rubber-based resins (e.g., polybutadiene (SBS)-based resin and polyisoprene (SIS)-based resin), polyamide-based resins and polyester-based resins,
(2) epoxy resins,
(3) urethane resins,
(4) natural rubbers, and synthetic rubbers such as styrene-butadiene-based rubber (SBR), acrylonitrile-butadiene-based rubber (NBR), ethylene propylene-based rubber (EPDM), chloroprene-based rubber (CR), isobutylene-isoprene-based rubber (IIR) and butadiene-based rubber (BR),
(5) acrylic resins such as second generation acrylic (SGA)-based resin,
(6) urea resins,
(7) melamine resins,
(8) phenol resins, and
(9) silicone resins including modified silicones.

A method of applying the above curable resin to the modified surface is not particularly limited, and various coating methods may be used therefor. Examples of the coating methods include direct application with brushes; coating methods using a curable resin-impregnated cloth; coating methods using a coating device such as a sprayer, a blade coater, an air-knife coater, a roll coater, a bar coater, a gravure coater, a flow coater and a curtain coater; dipping; and coating methods using a coating gun. Further, after applying the curable resin to the modified surface and joining to the counterpart member, the obtained joined article may be subjected to a heating treatment and a humidifying treatment if necessary in order to promote curing of the curable resin. In particular, in a case where the epoxy resin, the urethane resin or the silicone resin is used as the curable resin, it is preferred that the curable resin is cured at a temperature of 40° C. to 150° C. and a humidity of 30% RH to 100% RH to promote curing of the resin.

Among various curable resins described above, at least one resin selected from a group consisting of the acrylic resins, the urethane resins, the epoxy resins and the silicone resins is preferably used. By using the curable resins, excellent working efficiency, quick curing property and sufficient bonding durability of the obtained joined article can be realized.

Examples of the acrylic resins include thermoplastic acrylic resins, thermosetting acrylic resins, and moisture curable acrylic resins, though not particularly limited thereto, and various kinds of acrylic resins may be used. Specific examples of the thermoplastic acrylic resins include polymers and copolymers of acrylates or methacrylates such as methyl methacrylate and ethyl acrylate. Examples of the ester group of the esterified products may include alkyl groups such as methyl, ethyl, n-propyl, isopropyl, n-butyl, tert-butyl, n-hexyl, lauryl and stearyl. In the case of the copolymers of acrylates or methacrylates, two or more kinds of the ester groups may be used in combination with each other.

Examples of the thermosetting acrylic resins include polymers that are obtained by copolymerization of at least two monomers selected from the group consisting of monomers containing a functional group which are capable of forming a crosslinking structure in a molecule thereof, such as a carboxyl group, a hydroxyl group, an amino group, a methylol group, an epoxy group, e.g., acrylic acid, methacrylic acid, acrylamide, methacrylamide, N-methylol acrylamide, aryl glycidyl ether, and glycidyl metacrylate, and monomers not containing such a functional group, e.g., styrene, acrylates and methacrylates.

Examples of the moisture curable acrylic resins include methyl cyanoacrylate, ethyl cyanoacrylate, propyl cyanoacrylate and butyl cyanoacrylate. Among the above-described acrylic resins, the thermosetting acrylic resins or the moisture curable acrylic resins are preferred.

Further, the above-described acrylic resins can also contain various additives as necessary. Examples of the additives include the following.

(1) antioxidants such as hindered amine, hydroquinone, hindered phenol and sulfur-containing compounds,
(2) ultraviolet absorbers such as benzophenones, benzotriazoles, salicylic acid esters and metallic complex salts,
(3) weather-resistant stabilizers such as metallic soaps, inorganic salt compounds and organic salt compounds of heavy metals and organotin compounds,
(4) plasticizers such as phthalates, phosphates and fatty acid esters,
(5) waxes such as paraffin wax, polymerized wax, beewax, spermaceti wax and low molecular weight polyolefin wax,
(6) organic and inorganic fillers such as calcium carbonate, kaolin, talc, mica, bentonite, clay, carbon black, glass balloon, acrylic resin powder, phenol resin powder, ceramic powder, zeolite and titanium oxide,
(7) organic and inorganic fibers such as glass fiber, aramid fiber, carbon fiber, acrylic fiber, nylon fiber, polyester fiber, alumina fiber and boron fiber,
(8) antistatic agents,
(9) antibacterial agents,
(10) dehydrating agents,
(11) flame retardants,
(12) solvents,
(13) pigments,
(14) perfumes, and
(15) hardening accelerators.
These additives may be used in combination of any two or more thereof.

The above-described urethane resins as the curable resins are not particularly limited, and various kinds of urethane resins may be used as long as the urethane resins contain, as a constitutional unit, a compound having at least two isocyanate groups in a molecule thereof. Examples of the compound having at least two isocyanate groups in a molecule thereof include aromatic diisocyanates such as 2,4-tolylenediisocyanate (2,4-TDI), 2,6-tolylenediisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethyl xylylene diisocyanate (TMXDI), tolidine diisocyanate (TODI) and 1,5-naphthalene diisocyanate (NDI); aliphatic diisocyanates such as hexamethylenediisocyanate (HDI), trimethylhexamethylenediisocyanate (TMHDI), lysinediisocyanate and methyl norbornane diisocyanate (NBDI); alicyclic diisocyanates such as trans-cyclohexane-1,4-diisocyanate, isophorone diisocyanate (IPDI), H6-XDI (hydrogenated xylylene diisocyanate) and H12-MDI (hydrogenated diphenylmethane diisocyanate); and carbodiimide-modified diisocyanates or isocyanurate-modified diisocyanates of the above diisocyanates. The isocyanate compounds may be used alone or in combination of any two or more thereof. Among these isocyanate compounds, 4,4′-MDI, 2,4′-MDI, HDI, XDI and prepolymers of these compounds are preferred.

Further, polyol compounds may also be used in combination with the above compounds having at least two isocyanate groups in a molecule thereof for producing the urethane resins as necessary. The polyol compounds are not particularly limited, and various kinds of polyol compounds may be used as long as the polyol compounds contain at least two hydroxyl groups in a molecule thereof. Examples of the polyol compounds include polyethylene glycol (PEG), polypropylene glycol (PPG), polyether polyols such as polytetramethylene ether glycol (PTMG), and polyester polyols such as polyester polyols obtained by condensation and lactone-based polyester polyols. Among these polyol compounds, polyether polyols are preferred.

Further, the above urethane resins may also contain a catalyst, as necessary, in addition to the above compound having at least two isocyanate groups in a molecule thereof. The catalyst is not particularly limited, and any suitable catalyst may be used as long as the catalyst is capable of increasing or decreasing a curing rate of the urethane resins as necessary. Examples of the catalyst include monoamines such as triethylamine (TEA) and N,N′-dimethylcyclohexylamine (DMEDA), diamines such as N,N,N′,N′-tetramethylethylenediamine (TMEDA) and N,N,N′,N′-tetramethylhexane-1,6-diamine (TMHEDA), triamines such as N,N,N′,N″,N″-pentamethyldipropylene triamine (PMDPTA) and tetramethyl guanidine (TMG), cyclic amines such as triethylenediamine (TEDA), N,N′-dimethyl piperazine (DMP) and N-methylmorphorine (NMMO), and alcohol amines such as dimethylaminoethanol (DMEA) and N-methyl-N′-(2-hydroxyethyl)-piperazine (MHEP). Among these catalysts, the triamines and the cyclic amines are preferred.

Further, the above urethane resins may also contain additives as necessary, in addition to the above compound having at least two isocyanate groups in a molecule thereof. The additives are the same as described above, and may be used in combination of any two or more thereof.

The above-described epoxy resins are not particularly limited, and various kinds of epoxy resins may be used as long as the epoxy resins contain an epoxy compound having at least two epoxy groups in a molecule thereof together with a curing agent. Examples of the epoxy compound include bisphenol A type epoxy resins, bisphenol F type epoxy resins, bisphenol AD type epoxy resins, phenol novolak type epoxy resins, cresol novolak type epoxy resins, biphenyl type epoxy resins, glycidyl ester-based epoxy resins, alicyclic epoxy resins and heterocyclic epoxy resins. Among these epoxy resins, the bisphenol A type epoxy resins and the bisphenol F type epoxy resins are preferred.

Examples of the above-described curing agent include aliphatic amines such as ethylenediamine (EDA), diethylenetriamine (DETA), triethylenetetramine (TETA), tetraethylenepentamine (TEPA), isophoronediamine (IPDA) and N-aminoethylpiperazine (N-AEP); aliphatic aromatic amines such as m-xylenediamine (MXDA); aromatic amines such as m-phenylenediamine (MPDA), diaminodiphenyl methane (DDM) and diaminodiphenyl sulfone (DDS); other amines such as dicyandiamide (DICY) and adipic acid dihydrazide (AADH); modified polyamines such as epoxy compound-added polyamines, Michael-added polyamines and Mannich-added polyamines; polyamide amines; and acid anhydrides such as phthalic anhydride (PA), tetrahydrophthalic anhydride (THPA), hexahydrophthalic anhydride (HHPA), methyltetrahydrophthalic anhydride (MeTHPA), methylhexahydrophthalic anhydride (MeHHPA), methylnadic anhydride (MNA), dodecylsuccinic anhydride (DDSA), pyromellitic dianhydride (PMDA), benzophenonetetracarboxylic dianhydride (BTDA), ethylene glycol bis(anhydro-trimellitate) (TMEG), trimellitic anhydride (TMA) and polyazelaic polyanhydride (PAPA). Among these curing agents, the aliphatic amines, the other amines, the modified polyamines and the polyamide amines are preferred.

The above-described epoxy resins may also contain a catalyst as necessary, in addition to the epoxy compound having at least two epoxy groups in a molecule thereof together with the curing agent. The catalyst is not particularly limited, and any suitable catalyst may be used as long as the catalyst is capable of increasing or decreasing the curing rate of the epoxy resin as necessary. Examples of the catalyst include tertiary amines such as 2-(dimethylaminomethyl)phenol (DMP-10), 2,4,6-tris(dimethylaminomethyl)phenol (DMP-30), triethanolamine, tetramethylguanidene, pyridine, picoline, piperidine, pyrrolidine and 1,8-diazabicyclo(5,4,0)undecene-1 (DBU). Among these catalysts, DMP-10 and DMP-30 are preferred.

Further, the above-described epoxy resins may also contain various additives as necessary, in addition to the epoxy compound having at least two epoxy groups in a molecule thereof together with the curing agents. Examples of the additives are the same as described above. These additives may be used in combination of any two or more thereof.

Examples of the above-described silicone resins include thermosetting silicone resins and moisture curable silicone resins though not particularly limited thereto, and various kinds of silicone resins may be used. Specific examples of the thermosetting silicone resins include compounds containing a vinyl group-containing organopolysiloxane and a Si—H group-containing organohydropolysiloxane as main components which are obtained by using a platinum complex as a catalyst. Specific examples of the moisture-curable silicone resins include dealcoholization type silicone resins, deoximation type silicone resins, acetate removing type silicone resins, deamidation type silicone resins and acetone removing type silicone resins. Among the above silicone resins, the moisture-curable silicone resins are preferred.

The above silicone resins may also contain various additives as necessary. Examples of the additives include the same as described above. These additives may be used in combination of any two or more thereof.

A method of using these curable resins for producing the joined article is not particularly limited, and various coating methods may be used as long as the curable resins are applied to at least a portion of the modified surface, i.e., a portion of the surface of the surface modification layer, of the surface-modified member and then cured after the surface-modified member is joined with a counterpart member made of an optional material through the curable resins applied. However, in view of a good bonding durability of the obtained joined article, it is preferred that a curable resin solution prepared by diluting the curable resin with a solvent is applied to at least a portion of the modified surface, and after drying the modified surface to volatize the solvent, the curable resin is applied to the modified surface using a coating gun and the metal member is joined to the counterpart member and then the curable resin is cured. Further, a surface of the counterpart member which is joined with the modified surface of the surface-modified member may be coated with the curable resin solution, followed by drying the solution.

The bonding mechanism between the modified surface and the curable resin applied to the modified surface is explained as follows. As described above, by applying the energy to a surface of the metal member to be treated by the surface modifying method of the present invention, the metal or the metal alloy present on the surface of the metal member is chemically changed to the metal hydroxide to form a surface modification layer containing the metal hydroxide on the surface of the metal member. In addition, the surface of the metal member is suitably molten by a heat produced on the surface upon applying the energy thereto, whereby the irregular shape with microscopic recesses and projections is formed on the surface, resulting in production of the modified surface.

When the curable resin is applied to at least a portion of the modified surface of the surface-modified member, the hydroxyl group of the metal hydroxide present on the modified surface and the functional group such as an acrylic group, an epoxy group, an isocyanate group, and a hydroxyl group which is contained in the curable resin reacted with each other to form a chemical bond therebetween such as a covalent bond and a hydrogen bond. Further, the curable resin is infiltrated into irregularities formed on the modified surface to thereby increase a contact area between the modified surface and the curable resin applied to the modified surface at the bonding interface. This results in enhancing the surface energy-increasing effect and the anchoring effect, thereby improving the bonding force between the surface-modified member and the curable resin applied thereto. That is, the bonding force corresponds to a sum of the chemical surface modification effect due to the metal hydroxide produced on the metal surface and the physical surface modification effect due to the irregular shape formed on the metal surface. As a result, the surface-modified member obtained by the surface modifying treatment of the present invention can exhibit a considerably excellent bonding durability as compared to the conventional chemical treatment (chemical surface modification) and blasting treatment (physical surface modification).

The surface-modified member of the present invention may also be subjected to printing or coating with an ink or a coating material to form an ink layer or a coating material layer on at least a portion of the surface of the surface modification layer. The surface-modified member of the present invention can ensure an excellent bonding (adhesion) property to the ink layer or the coating material layer owing to the above-described chemical and physical effects obtained by the bonding mechanism.

The ink or the coating material useable in the printing or coating is not particularly limited, and various inks or coating materials may be used as long as the ink or the coating material is applicable to at least a portion or a whole of the surface of the surface modification layer in the surface-modified member, and exhibits the inherent function of the ink or the coating materials.

Specific examples of the ink include offset printing inks, printing inks, rotogravure inks and architecture inks. Specific examples of the coating material include coating materials for plastics, coating materials for metals, coating materials for ceramics, coating materials for synthetic leather, electrically conductive coating materials, insulating coating materials, ultraviolet curable coating materials and electron beam-curable coating materials. The method of applying these inks or coating materials to the modified surface of the surface-modified member may be the same method as used for coating the curable resin as described above.

### EXAMPLES

The present invention is described in more detail by way of examples and comparative examples by referring to the accompanying drawings. However, these examples are only illustrative and not intended to limit a scope of the present invention thereto.

### Example 1

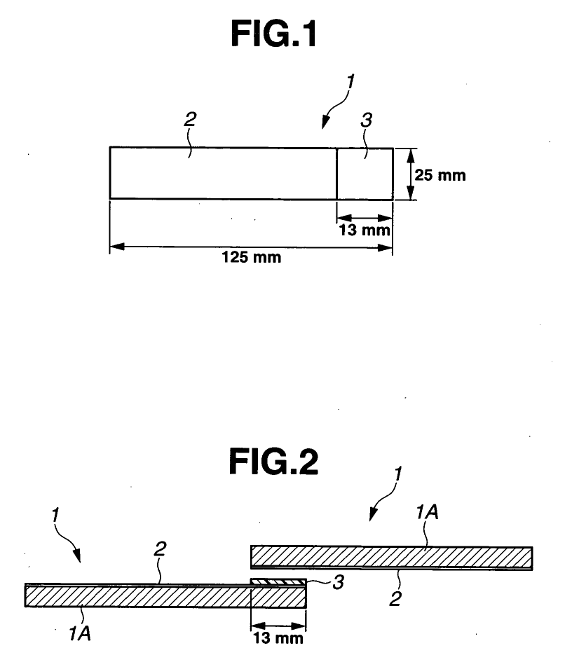

A test piece of surface-modified member 1 as shown in FIG. 1, was prepared in the following manner. The whole of one side surface of a plate made of aluminum alloy (ADC12 prescribed in JIS H 5302) having a size of 25 mm in width, 125 mm in length and 3 mm in thickness was subjected to surface modification treatment by laser irradiation. The laser irradiation was conducted using a YVO₄ laser irradiation apparatus (ML-7111A, manufactured by Miyachi Technos Corp.) under the following irradiation conditions: electric current: 25 A; frequency: 15 kHz; irradiation rate: 500 mm/s; wavelength: 1064 nm; irradiation intensity: 7800 W/mm². As a result, surface modification layer 2 was formed over the whole of the one side surface of the alloy plate serving as a metal base. Thus, the test piece having a modified surface, i.e., surface modification layer 2, on the metal base was obtained. Next, the test piece was subjected to evaluations of a condition of the modified surface thereof, an irregularity of the modified surface thereof (measurement of Ra/Rao, Sm/Smo), a thickness of the surface modification layer formed thereon, an initial effect (wettability), an initial bonding property thereof and a bonding durability thereof by the following methods. The results of the evaluation test were shown in Table 1.

[Evaluation Methods]

(Surface Condition)

After cooling the thus surface-modified test piece at room temperature for 5 minutes, binding energy values (chemical shift) of respective metal atoms present on the modified surface were measured using an X-ray photoelectron spectroscopic analyzer (JPS-9200 manufactured by JEOL Ltd.), and the binding conditions of the metal atoms were confirmed on the basis of the binding energy values measured. Specifically, when the metal atom to be analyzed is aluminum atom, it is known that intense absorption is observed at about 72.9 eV for metal aluminum, at about 74.0 eV for aluminum hydroxide, at about 74.7 eV for aluminum oxide film and at about 73-74 eV for aluminum oxide. The binding condition of aluminum atom on the modified surface was determined on the basis of this information. Similarly, when the metal atom to be analyzed is magnesium atom, it is known that intense absorption is observed at about 49.8 eV for metal magnesium, at about 49.5 eV for magnesium hydroxide and at about 50.8 eV for magnesium oxide. The binding condition of magnesium atom on the modified surface was determined on the basis of this information.

(Ra/Rao)

After cooling the test piece under the same conditions as described above, a roughness curve of the modified surface was measured from an optional measuring point on the modified surface using a laser non-contact surface roughness meter (Chapman MP2100, manufactured by RAYTEX CORP.). A reference length of 4 mm was sampled from the roughness curve along a direction of a mean line. An absolute value of deviation of the roughness curve in the reference length from the mean line was measured at optional five measuring points. An average value of the absolute values measured at the optional five measuring points was calculated as arithmetical mean roughness (Ra). Arithmetical mean roughness (Rao) of the surface of the test piece before treated by the surface modifying treatment was previously calculated using the laser non-contact surface roughness meter in the same manner as described above. The ratio Ra/Rao between the arithmetical mean roughness Ra of the modified surface of the test piece and the arithmetical mean roughness Rao of the surface of the test piece before the surface modifying treatment was calculated.

(Sm/Smo)

A roughness curve of the modified surface of the test piece was measured using the laser non-contact surface roughness meter in the same manner as described above, and a reference length was sampled from the roughness curve in the same manner as described above. A length of the mean line that corresponds to a distance between one peak and one valley adjacent to the peak in the reference length was measured at optional five measuring points on the roughness curve. An average value of the lengths of the mean line as measured at each of the five measuring points was calculated as average distance (Sm) between the adjacent peak and valley. Average distance (Smo) between the adjacent peak and valley on the surface of the test piece before treated by the surface modifying treatment was previously calculated using the laser non-contact surface roughness meter in the same manner as described above. The ratio Sm/Smo between the average distance Sm between the adjacent peak and valley on the modified surface of the test piece and the average distance Smo between the adjacent peak and valley on the surface of the test piece before the surface modifying treatment was calculated.

(Thickness of Surface Modification Layer)

After cooling the test piece as described above, the test piece was cut in a sectional direction perpendicular to the one side surface. The section of the cut test piece was observed near the modified surface to measure a thickness of the surface modification layer by using a scanning electron microscope (SSX-550, manufactured by Shimadzu Seisakusho Co.) at a magnification of about 3000 times.

(Initial Effect—Wettability)

After cooling the test piece as described above, a wetting reagent (standard solution having wetting indexes of 73-40, manufactured by Wako Junyaku Kogyo Co.) was applied to the modified surface over a length of about 3 cm using a swab. Subsequently, the modified surface was observed whether or not the modified surface was kept wetted with the applied reagent without repelling for a period of 5 seconds after applying the reagent thereto. Among the wetting indexes of the standard solution which indicates a wetting condition of the modified surface, the largest wetting index was used as wettability (dyn) of the modified surface. When the modified surface was wetted using the standard solution having a wetting index of 73, the wettability of the modified surface was indicated by “≧73”. On the other hand, when the modified surface was not wetted using the standard solution having a wetting index of 40, the wettability of the modified surface was indicated by “<40”.

(Initial Bonding Property)

As shown in FIG. 2, an epoxy-based adhesive (Sundine 2403 manufactured by Asahi Rubber Co. Ltd., hereinafter referred to as “adhesive A”) was applied to the modified surface of the test piece, i.e., the surface of surface modification layer 2, over an area extending from an end of the modified surface by a length of 13 mm, using a coating gun. Thus, the test piece of surface modified member 1 that had surface modification layer 2 on metal base 1A and adhesive layer 3 on surface modification layer 2, was obtained. Subsequently, as shown in FIG. 2, an end portion of the modified surface of another surface-modified member 1 as the counterpart member was bonded to the adhesive-applied area of the modified surface of the test piece to prepare a bonding test specimen. The thus prepared bonding test specimen was held within a thermostat chamber (SMS-2 manufactured by Tabai Espec Co.) previously controlled to a temperature 170° C. for 30 minutes, and then cured for 24 hours at room temperature in order to harden adhesive layer 3. This curing process was conducted so as to form cured adhesive layer 3 having 100 μm or less between surface modification layer 2 of the test piece and surface modification layer 2 of the counterpart member which were bonded to each other. The bonding test specimen was then subjected to a tensile shear test using a tester “Autograph” (AG-I 20kN manufactured by Shimadzu Seisakusho Co.) at a tensile rate (pulling velocity) of 50 mm/min to measure a shear strength of the bonding test specimen. After completion of the tensile shear test, a ratio of a surface area on adhesive layer 3 in which occurrence of cohesion and fracture in the adhesive was found by visual observation, to the entire surface area of adhesive layer 3 (cohesion-fracture ratio) was measured.

(Bonding Durability)

The test piece and the counterpart member were bonded to each other in the same manner as described above and the obtained bonding test specimen was held within a pressure cooker tester (EHS-220M manufactured by Tabai Espec Co.) previously controlled to a temperature 120° C. for 72 hours, and then cured in the same manner as described above. The bonding test specimen was thus subjected to the same tensile shear test as described above in the Initial Bonding Property.

### Example 2

The same procedure as in Example 1 was repeated except that the irradiation intensity of the laser was changed to 3800 W/mm², thereby obtaining a test piece of a surface-modified member. The thus obtained test piece was subjected to various evaluation tests by the same methods as described in Example 1. The results of the evaluation tests are shown in Table 1.

### Example 3

The same procedure as in Example 1 was repeated except that the surface modification treatment was conducted by using a YVO₄ laser irradiation apparatus (ML-9001A manufactured by Miyachi Technos Corp.) with a laser wavelength of 532 nm and at irradiation intensity of 3800 W/mm², thereby obtaining a test piece of a surface-modified member. The thus obtained test piece was subjected to various evaluation tests by the same methods as described in Example 1. The results of the evaluation tests are shown in Table 1.

### Example 4

The same procedure as in Example 1 was repeated except that the aluminum alloy used in Example 1 was replaced with an extruded aluminum alloy plate (7075 prescribed in JIS H 4000) and the irradiation intensity of the laser was changed to 980 W/mm², thereby obtaining a test piece of a surface-modified member. The thus obtained test piece was subjected to evaluations of a modified surface condition thereof, an irregularity of the modified surface thereof, a thickness of a surface modification layer formed thereon, an initial effect (wettability) thereof and an initial bonding property thereof by the same methods as described in Example 1 except that a modified silicone-based adhesive (Super X No. 8008 manufactured by Semedine Co.; hereinafter referred to as “adhesive B”) was used, and the resultant test piece was held at room temperature for 7 days and cured to evaluate the initial bonding property thereof. The results of the evaluation tests are shown in Table 1.

### Example 5

The same procedure as in Example 1 was repeated except that the aluminum alloy plate used in Example 1 was replaced with a magnesium alloy plate (AZ91 prescribed in SAE J465) having a size of 25 mm in width, 125 mm in length and 4 mm in thickness, thereby obtaining a test piece of a surface-modified member. The thus obtained test piece was subjected to evaluations of a modified surface condition thereof, an irregularity of the modified surface, a thickness of a surface modification layer, initial effect (wettability) and initial bonding property by the same methods as described in Example 1. The results of the evaluation tests are shown in Table 1.

### Example 6

The same procedure as described in Example 2 was repeated except that the aluminum alloy plate used in Example 2 was replaced with a magnesium alloy plate (AZ91 prescribed in SAE J465) having a size of 25 mm in width, 125 mm in length and 4 mm in thickness, thereby obtaining a test piece of a surface-modified member. The thus obtained test piece was subjected to evaluations a modified surface condition, an irregularity of the modified surface thereof, a thickness of a surface modification layer formed thereon, an initial effect (wettability) thereof and an initial bonding property thereof by the same methods as described in Example 1. The results of the evaluation tests are shown in Table 1.

### Example 7

The same procedure as described in Example 3 was repeated except that the aluminum alloy plate used in Example 3 was replaced with a magnesium alloy plate (AZ91 prescribed in SAE J465) having a size of 25 mm in width, 125 mm in length and 4 mm in thickness, thereby obtaining a test piece of a surface-modified member. The thus obtained test piece was subjected to evaluations of a modified surface condition thereof, an irregularity of the modified surface thereof, a thickness of the surface modification layer formed thereon, an initial effect (wettability) thereof and an initial bonding property thereof by the same methods as described in Example 1. The results of the evaluation tests are shown in Table 1.

### Example 8

The same procedure as described in Example 4 was repeated except that the aluminum alloy plate used in Example 4 was replaced with a magnesium alloy plate (AZ61 prescribed in SAE J465) having a size of 25 mm in width, 125 mm in length and 4 mm in thickness, thereby obtaining a test piece of a surface-modified member. The thus obtained test piece was subjected to evaluations of a modified surface condition thereof, an irregularity of the modified surface thereof, a thickness of the surface modification layer formed thereon, an initial effect (wettability) thereof and an initial bonding property thereof by the same methods as described in Example 1 except that a synthetic rubber-based adhesive (S465 manufactured by Semedine Co., hereinafter referred to as “adhesive C”) was used, and the test piece was held at room temperature for 7 days and cured to evaluate the initial bonding property thereof. The results of the evaluation tests are shown in Table 1.

### Comparative Example 1

The surface of an aluminum alloy plate (ADC12 prescribed in JIS H 5302) having a size of 25 mm in width, 125 mm in length and 3 mm in thickness was cleaned and degreased with a cloth impregnated with ethyl alcohol. The thus treated aluminum alloy plate was directly subjected, without being surface-modified, to evaluations of a condition of the surface thereof, an irregularity of the surface thereof, an initial effect (wettability) thereof, an initial bonding property thereof and a bonding durability thereof by the same methods as described in Examples 1 to 3. The results of the evaluation tests are shown in Table 2.

### Comparative Example 2

The surface of an aluminum alloy plate (ADC12 prescribed in JIS H 5302) having a size of 25 mm in width, 125 mm in length and 3 mm in thickness was lightly polished with #320 grit sand paper in one direction for 1 minute and then cleaned and degreased with an ethyl alcohol-impregnated cloth. The thus treated aluminum alloy plate was directly subjected, without being surface-modified, to evaluations of a condition of the surface thereof, an irregularity of the surface thereof, an initial effect (wettability) thereof and an initial bonding property thereof by the same methods as described in Comparative Example 1. The results of the evaluation tests are shown in Table 2.

### Comparative Example 3

The surface of an aluminum alloy plate (ADC12 prescribed in JIS H 5302) having a size of 25 mm in width, 125 mm in length and 3 mm in thickness was subjected to chemical conversion treatment using a magnesium phosphate-based solution and then cleaned and degreased with an ethyl alcohol-impregnated cloth. The thus treated aluminum alloy plate was subjected to evaluations of a surface condition thereof, an irregularity of the surface thereof, an initial effect (wettability) thereof and an initial bonding property thereof by the same methods as described in Comparative Example 1. The results of the evaluation tests are shown in Table 2.

### Comparative Example 4

The surface of an aluminum alloy plate (7075 prescribed in JIS H 4000) having a size of 25 mm in width, 125 mm in length and 3 mm in thickness was cleaned and degreased with a cloth impregnated with ethyl alcohol. The thus treated aluminum alloy plate was directly subjected, without being surface-modified, to evaluations of a condition of the surface thereof, an irregularity of the surface thereof, an initial effect (wettability) thereof and an initial bonding property thereof by the same methods as described in Comparative Example 1 except that the adhesive B was used and cured in the same manner as described in Example 4 to evaluate the initial bonding property. The results of the evaluation tests are shown in Table 2.

### Comparative Example 5

The surface of a magnesium alloy plate (AZ91 prescribed in SAE J465) having a size of 25 mm in width, 125 mm in length and 3 mm in thickness was subjected to chemical conversion treatment using a magnesium phosphate-based solution and then cleaned and degreased with an ethyl alcohol-impregnated cloth. The thus treated magnesium alloy plate was subjected to evaluations of a surface condition thereof, an irregularity of the surface thereof, an initial effect (wettability) thereof and an initial bonding property thereof by the same methods as described in Comparative Example 1. The results of the evaluation tests are shown in Table 2.

### Comparative Example 6

The surface of a magnesium alloy plate (AZ91 prescribed in SAE J465) having a size of 25 mm in width, 125 mm in length and 3 mm in thickness was lightly polished with #320 grit sand paper in one direction for 1 minute and then cleaned and degreased with an ethyl alcohol-impregnated cloth. The thus treated magnesium alloy plate was directly subjected, without being surface-modified, to evaluations of a condition of the surface thereof, an irregularity of the surface thereof, an initial effect (wettability) thereof and an initial bonding property thereof by the same methods as described in Comparative Example 1. The results of the evaluation tests are shown in Table 2.

### Comparative Example 7

The surface of a magnesium alloy plate (AZ91 prescribed in SAE J465) having a size of 25 mm in width, 125 mm in length and 3 mm in thickness was subjected to chemical conversion treatment using a magnesium phosphate-based solution and then cleaned and degreased with an ethyl alcohol-impregnated cloth. The thus treated magnesium alloy plate was subjected to evaluations of a surface condition thereof, an irregularity of the surface thereof, an initial effect (wettability) thereof and an initial bonding property thereof by the same methods as described in Comparative Example 1. The results of the evaluation tests are shown in Table 2.

### Comparative Example 8

The surface of a magnesium alloy plate (AZ61 prescribed in SAE J465) having a size of 25 mm in width, 125 mm in length and 3 mm in thickness was cleaned and degreased with a cloth impregnated with ethyl alcohol. The thus treated magnesium alloy plate was directly subjected, without being surface-modified, to evaluations of a condition of the surface thereof, an irregularity of the surface thereof, an initial effect (wettability) thereof and an initial bonding property thereof by the same methods as described in Comparative Example 1 except that the adhesive C used in Example 8 was used to evaluate the initial bonding property. The results of the evaluation tests are shown in Table 2.

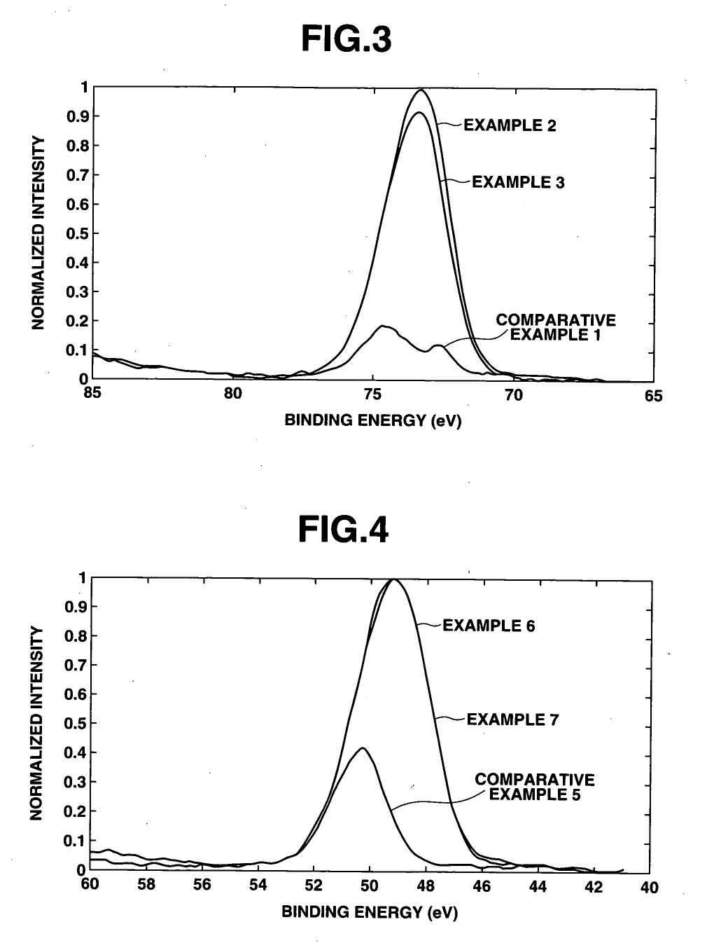

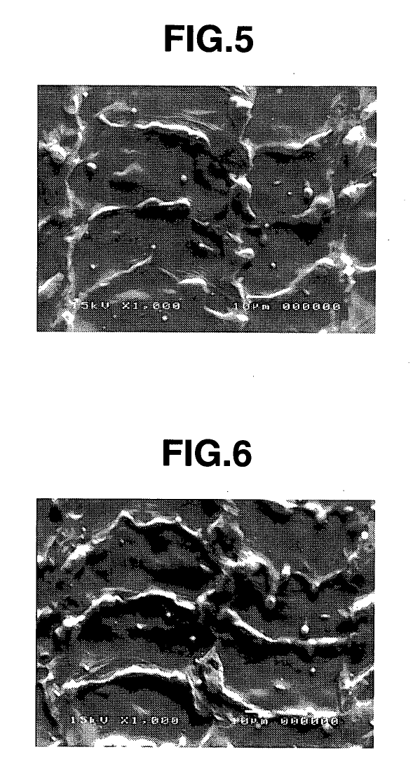

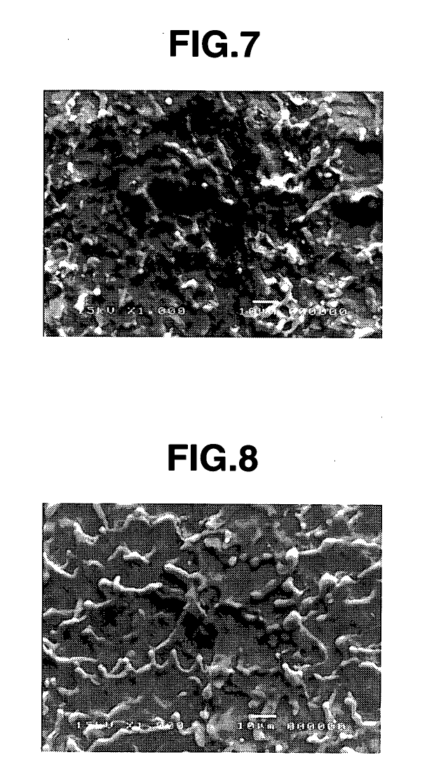

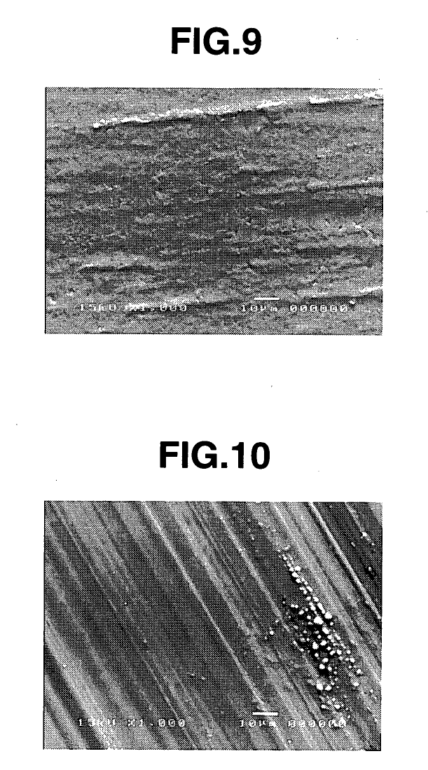

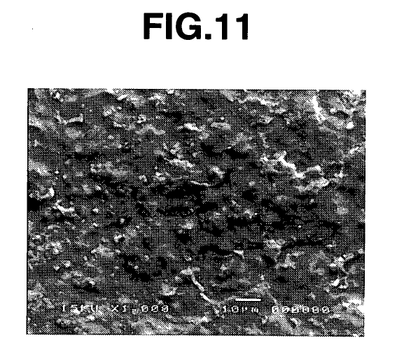

As typical examples of results of investigation of the surface conditions, the results of the X-ray photoelectron spectroscopic analysis of Example 2, Example 3 and Comparative Example 1 are shown in FIG. 3, and the results of the X-ray photoelectron spectroscopic analysis of Example 6, Example 7 and Comparative Example 5 are shown in FIG. 4. Further, as examples of a configuration of the treated surface, SEM observation images of the surface of the test pieces used in Example 2, Example 3, Example 6 and Example 7 are shown in FIG. 5 to FIG. 8, and SEM observation images of the surface of the test pieces used in Comparative Example 1 (untreated), Comparative Example 6 (polished) and Comparative Example 7 (chemical conversion-treated) are shown in FIG. 9 to FIG. 11.

TABLE 1

Conditions of Surface Modification

| | | Laser | Irradiation | Metal Member |
|---|---|---|---|---|
| | Energy | Wavelength | Intensity | Treated |
| zebra | Source | (nm) | (W/mm²) | Material |
| Example 1 | Laser | 1064 | 7800 | Aluminum Alloy |
| | Irradiation | | | ADC12 |
| Example 2 | Laser | 1064 | 3800 | Aluminum Alloy |
| | Irradiation | | | ADC12 |
| Example 3 | Laser | 532 | 980 | Aluminum Alloy |
| | Irradiation | | | ADC12 |
| Example 4 | Laser | 1064 | 980 | Aluminum Alloy |
| | Irradiation | | | 7075 |
| Example 5 | Laser | 1064 | 7800 | Magnesium Alloy |
| | Irradiation | | | AZ91 |
| Example 6 | Laser | 1064 | 3800 | Magnesium Alloy |
| | Irradiation | | | AZ91 |
| Example 7 | Laser | 532 | 980 | Magnesium Alloy |
| | Irradiation | | | AZ91 |
| Example 8 | Laser | 1064 | 980 | Magnesium Alloy |
| | Irradiation | | | AZ61 |

Surface Condition After Surface Modification Treatment

| | Thickness of |
|---|---|
| | Surface |
| | Modification |
| Surface Roughness | Layer |

| zebra | Surface condition | Ra/Rao | Sm/Smo | (μm) |
|---|---|---|---|---|
| Example 1 | Aluminum Hydroxide | 8.8 | 0.9 | 1 |
| Example 2 | Aluminum Hydroxide | 9.0 | 0.8 | 1 |
| Example 3 | Aluminum Hydroxide | 9.1 | 0.4 | 1 |
| Example 4 | Aluminum Hydroxide | 8.4 | 0.4 | 1 |
| Example 5 | Magnesium Hydroxide | 2.8 | 0.7 | 1 |
| Example 6 | Magnesium Hydroxide | 3.0 | 0.7 | 1 |
| Example 7 | Magnesium Hydroxide | 4.1 | 0.7 | 1 |
| Example 8 | Magnesium Hydroxide | 4.3 | 0.8 | 1 |

| | Surface Modification Effects | | | | | |
|---|---|---|---|---|---|---|
| | | | Initial Bonding | | | |
| | Initial | | Property | | Bonding Durability | |
| | Effect | Curable | Shear | Cohesion- | Shear | Cohesion- |
| | Wettability | Resin | Strength | Fracture | Strength | Fracture |
| zebra | (dyn) | Adhesive | (MPa) | Ratio (%) | (MPa) | Ratio (%) |
| Example 1 | ≧73 | Adhesive | 22.9 | 100 | 10.3 | 100 |
| | | A*¹ | | | | |
| Example 2 | ≧73 | Adhesive | 23.1 | 100 | 9.7 | 100 |
| | | A*¹ | | | | |
| Example 3 | ≧73 | Adhesive | 21.2 | 100 | 9.5 | 100 |
| | | A*¹ | | | | |
| Example 4 | ≧73 | Adhesive | 4.9 | 100 | — | — |
| | | B*² | | | | |
| Example 5 | ≧73 | Adhesive | 22.8 | 100 | — | — |
| | | A*¹ | | | | |
| Example 6 | ≧73 | Adhesive | 22.6 | 100 | — | — |
| | | A*¹ | | | | |
| Example 7 | ≧73 | Adhesive | 20.2 | 100 | — | — |
| | | A*¹ | | | | |
| Example 8 | ≧73 | Adhesive | 0.7 | 100 | — | — |
| | | C*³ | | | | |

Notes for TABLE 1
*¹Adhesive A indicates Sundine 2403 manufactured by Asahi Rubber Co. Ltd.
*²Adhesive B indicates Super X No. 8008 manufactured by Semedine Co.
*³Adhesive C indicates S465 manufactured by Semedine Co.

TABLE 2

| | Treatment Conditions | | | | |
|---|---|---|---|---|---|
| | | Metal | Surface Condition | | |
| | | Member | After Treatment | | |
| | Treatment | Treated | Surface | Surface Roughness | |
| | Method | Material | Condition | Ra/Rao | Sm/Smo |
| Comparative | Untreated | Aluminum | Aluminum + | — | — |
| Example 1 | | Alloy | OF*¹ + | | |
| | | ADC12 | MRA*² | | |
| Comparative | Polishing | Aluminum | Aluminum + | 2.4 | 0.9 |
| Example 2 | | Alloy | OF¹ + | | |
| | | ADC12 | MRA*² | | |
| Comparative | Chemical | Aluminum | CF*³ | 4.2 | 4.1 |
| Example 3 | Conversion | Alloy | | | |
| | Treatment | ADC12 | | | |
| Comparative | Untreated | Aluminum | Aluminum + | — | — |
| Example 4 | | Alloy | OF*¹ | | |
| | | 7075 | | | |
| Comparative | Untreated | Magnesium | Magnesium + | — | — |
| Example 5 | | Alloy | MRA*² | | |
| | | AZ91 | | | |
| Comparative | Polishing | Magnesium | Magnesium + | 1.1 | 0.2 |
| Example 6 | | Alloy | MRA*² | | |
| | | AZ91 | | | |
| Comparative | Chemical | Magnesium | CF*³ | 0.9 | 0.4 |
| Example 7 | Conversion | Alloy | | | |
| | Treatment | AZ91 | | | |
| Comparative | Untreated | Magnesium | Magnesium + | — | — |
| Example 8 | | Alloy | MRA*² | | |
| | | AZ61 | | | |

| | Treatment Effects | | | | | |
|---|---|---|---|---|---|---|
| | | | Initial Bonding | | | |
| | Initial | | Property | | Bonding Durability | |
| | Effect | Curable | Shear | Cohesion- | Shear | Cohesion- |
| | Wettability | Resin | Strength | Fracture | Strength | Fracture |
| | (dyn) | Adhesive | (MPa) | Ratio (%) | (MPa) | Ratio (%) |
| Comparative | 43 | Adhesive | 20.4 | 90 | 1.5 | 35 |
| Example 1 | | A*⁴ | | | | |
| Comparative | 45 | Adhesive | 18.9 | 80 | — | — |
| Example 2 | | A*⁴ | | | | |
| Comparative | <40 | Adhesive | 8.2 | 15 | — | — |
| Example 3 | | A*⁴ | | | | |
| Comparative | 43 | Adhesive | 3.1 | 55 | — | — |
| Example 4 | | B*⁵ | | | | |
| Comparative | <40 | Adhesive | 20.5 | 70 | — | — |
| Example 5 | | A*⁴ | | | | |
| Comparative | <40 | Adhesive | 20.7 | 80 | — | — |
| Example 6 | | A*⁴ | | | | |
| Comparative | <40 | Adhesive | 9.0 | 10 | — | — |
| Example 7 | | A*⁴ | | | | |
| Comparative | <40 | Adhesive | 0.4 | 15 | — | — |
| Example 8 | | C*⁶ | | | | |

Notes for TABLE 2
*¹OF indicates oxide film.
*²MRA indicates mold release agent.
*³CF indicates chemical conversion film.
*⁴Adhesive A indicates Sundine 2403 manufactured by Asahi Rubber Co. Ltd.
*⁵Adhesive B indicates Super X No. 8008 manufactured by Semedine Co.
*⁶Adhesive C indicates S465 manufactured by Semedine Co.

As shown in Table 1, it was confirmed that the surface modification layer containing an aluminum hydroxide was formed on the aluminum alloy member subjected to the surface modifying treatment in Examples 1 to 4, and the surface modification layer containing a magnesium hydroxide was formed on the magnesium alloy member subjected to the surface modifying treatment in Examples 5 to 8. It was recognized that owing to production of the surface modification layer, the surface-modified member exhibited an excellent initial effect (wettability) and also the joined article formed by joining the surface-modified member and the counterpart member through the curable resin exhibited an excellent initial bonding property and bonding durability.

In contrast, as shown in Table 2, it was confirmed that no metal hydroxide was present on the surface of the alloy members used in Comparative Examples 1 to 8 in which the alloy members were untreated, polished and subjected to the chemical conversion treatment. Further, it was confirmed that metal aluminum, aluminum oxide or magnesium oxide was present on the surface of the alloy members. In addition, it was confirmed that the mold release agent on the basis of a carbon content of the alloy members remained on the surface of the alloy members. Thus, it was recognized that the alloy members used in Comparative Examples 1 to 8 were deteriorated in wettability and adhesive strength as compared to the surface-modified alloy members used in Examples 1 to 8.

This application is based on a prior Japanese Patent Application No. 2007-027523 filed on Feb. 7, 2007, the entire contents of which is hereby incorporated by reference.

Although the invention has been described above by reference to embodiments and examples of the invention, the invention is not limited to the embodiments and examples described above. Modifications and variations of the embodiments and examples described above will occur to those skilled in the art in light of the above teachings. The scope of the invention is defined with reference to the following claims.

What is claimed is:

1. A surface-modified member comprising:
a metal base;
a surface modification layer formed on at least a part of a surface of the metal base, the surface modification layer containing a metal hydroxide; and
at least one of a curable resin layer, an ink layer and a coating material layer which is provided on at least a portion of the surface modification layer.

2. The surface-modified member as claimed in claim 1, wherein the metal base is made of one material selected from the group consisting of an aluminum alloy and a magnesium alloy.

3. The surface-modified member as claimed in claim 1, wherein the surface modification layer is formed by at least one treatment selected from the group consisting of a laser treatment, a plasma treatment, an ultraviolet irradiation treatment, a corona treatment and a flame treatment.

4. The surface-modified member as claimed in claim 3, wherein the laser treatment is carried out by irradiation with a laser light having a wavelength of 500 to 1,100 nm at irradiation intensity of 100 to 90,000 W/mm².

5. The surface-modified member as claimed in claim 1, wherein the surface modification layer has a thickness of 5 μm or less.

6. The surface-modified member as claimed in claim 1, wherein the surface modification layer has on a surface thereof, an irregularity satisfying a relation represented by the following expressions (1) and (2):
1≦Ra/Rao≦20 (1),
wherein Ra represents an arithmetical mean roughness of the surface of the surface modification layer, and Rao represents an arithmetical mean roughness of the surface of the metal base before being modified, and
Sm/Smo≦8 (2),
wherein Sm represents an average distance between a valley and a peak adjacent to each other on the surface of the surface modification layer, and Smo represents an average distance between a valley and a peak adjacent to each other on the surface of the metal base before being modified.

7. The surface-modified member as claimed in claim 6, wherein the surface modification layer has a thickness of 5 μm or less.

8. The surface-modified member as claimed in claim 1, wherein the curable resin layer is made of at least one resin selected from the group consisting of acrylic resins, urethane resins, epoxy resins and silicone resins.

9. A method of modifying a surface of a metal member, the method comprising:
applying an energy to at least a part of the surface of the metal member to produce a metal hydroxide on the surface of the metal member.

10. The method as claimed in claim 9, wherein the metal member is made of one material selected from the group consisting of an aluminum alloy and a magnesium alloy.

11. The method as claimed in claim 9, wherein the energy is applied to the surface of the metal member by at least one treatment selected from the group consisting of a laser treatment, a plasma treatment, an ultraviolet irradiation treatment, a corona treatment and a flame treatment.

12. The method as claimed in claim 11, wherein the laser treatment is carried out by irradiation with a laser light having a wavelength of 500 to 1,100 nm at irradiation intensity of 100 to 90,000 W/mm².

13. A joined article comprising the surface-modified member as claimed in claim 1, and a counterpart member that is joined to the surface-modified member through the curable resin layer provided on the at least a portion of the surface modification layer.

14. A method of producing a joined article using the surface-modified member as claimed in claim 1, the method comprising:
joining the surface-modified member to a counterpart member through the curable resin layer provided on the at least a portion of the surface modification layer.
